(19) United States
(12) Patent Application Publication
(10) Pub. No.: US 2022/0227535 A1
(43) Pub. Date: Jul. 21, 2022

(54) Reusable Smart Container

(71) Applicant: Brian Benjamin Management LLC, Chicago, IL (US)

(72) Inventor: Brian David Benjamin, Chicago, IL (US)

(73) Assignee: Brian Benjamin Management LLC, Chicago, IL (US)

(21) Appl. No.: 17/573,767

(22) Filed: Jan. 12, 2022

Related U.S. Application Data
(60) Provisional application No. 63/139,870, filed on Jan. 21, 2021.

(51) Int. Cl. B65D 25/10

(52) U.S. Cl. CPC B65D 25/10; B65D 2201/00; B65D 2203/10

(57) ABSTRACT

A reusable container includes a container portion and a microcontroller device. The microcontroller device includes a microcontroller and a wireless communication device. The wireless communication device is configured for wireless communication with a local area network including at a least a first radio receiver or the first radio receiver and a first computer. The local area network is external to the reusable container. The local area network is configured to determine location data corresponding to a location of the container based on at least a location of the radio receiver or the first computer. The microcontroller is configured to store the location data.

### CROSS REFERENCE TO RELATED APPLICATIONS

The present application claims the benefit of the filing date of U.S. Provisional Patent Application No. 63/139,870 filed Jan. 21, 2021, the disclosure of which is hereby incorporated by reference.

### BACKGROUND

In many industries, such as foodservice, hospitality, e-commerce, etc., disposable containers are commonly used to store and transport goods. Disposable containers are generally intended for a one-time use before being disposed of in waste or recycling streams. The value of a disposable container is no greater than its cost, and the value may even be diminished further at a higher rate of disposal which corresponds to increased costs.

Reusable containers or packaging provide an alternative to disposable containers. Although manufacturing and acquisition costs of reusable containers are generally greater than those of disposable containers, reusable containers are valued at a competitive cost per use. These containers are typically viable when the total value/cost per use is greater than that of a disposable alternative. Reusable containers may also provide added value with features and benefits that are economically feasible in a reusable model but not in a single-use model.

Current containers include electronic components used to carry data related to the container and global positioning system (GPS) location logging to reduce loss or damage to the goods contained therein. The GPS logging function permits detecting a deviation from a planned transit route. Production, installation and maintenance of a GPS unit for placement on each individual container can be highly costly. Other forms of loss include in-transit damage or unexpected variation in temperature. Containers that cannot adequately protect and/or prevent spoilage of the goods in which they are transporting may add significant costs to the users of the container, such as the shipping company.

Accordingly, further developments in the art of reusable containers would be desirable to improve the value of the containers by reducing shipping costs and improving container functionality.

### BRIEF SUMMARY OF THE DISCLOSURE

In accordance with the present disclosure, a reusable container may be used for the storage and transportation of goods, e.g., in the foodservice or hospitality industries, or other similar applications. The reusable container may reduce waste and recycling handling costs along with having improved environmental benefits due to the reduced environmental footprint. The reusable container may include enhanced durability and information technology features, including 2-way communication capability. The reusable container may include any or all of the features described in detail below, some of which may be customizable to optimize cost and value for specific end-user scenarios. For example, certain features may be included or omitted (when omitting features would reduce the cost of the device without negatively impacting value).

The reusable container may sense, measure and record information about the details of the state of the container while in transit. For example, the container may record an internal temperature, humidity, shock/vibration, or pressure, among other things. The container may display the information to a user directly on the container, and may also provide the information remotely by communicating with a wireless receiver through a wireless radio included in the container. The wireless radio may ping various wireless receivers in transit to identify the location of the container at a given time. By making use of wireless receivers already incorporated in the supply chain (e.g., computers, smartphones, etc.) the containers may improve the cost of shipping by tracking location with low-cost means and providing a user with important information to deliver a product while reducing the likelihood and frequency of damage to the product.

In certain embodiments, a reusable container may include a container portion and a microcontroller device. The microcontroller device may include a microcontroller and a wireless communication device. The wireless communication device may be configured for wireless communication with a local area network including at least a first radio receiver or the first radio receiver and a first computer. The local area network may be external to the reusable container. The local area network may determine location data corresponding to a location of the container based on at least a location of the radio receiver or the first computer. The microcontroller may be configured to store the location data.

The wireless communication device may be a Bluetooth® low energy wireless radio. The radio receiver may be part of a local area network including a first computer. The microcontroller may include firmware programmed onto the microcontroller and may be configured to be updated wirelessly upon the microcontroller device receiving update signals corresponding to firmware update instructions from the local area network. The firmware update instructions may correspond to custom updates provided by an external user as desired by the user.

The container portion may include a first panel, a second panel, a third panel, a fourth panel, a fifth panel and a sixth panel. The first panel may have a substantially rectangular shape defining first, second, third, and fourth edges. The second panel may be hingedly coupled to the first edge of the first panel. The third panel may be hingedly coupled to the second edge of the first panel, the third panel being perpendicular to the second panel in the upright configuration. The fourth panel may be hingedly coupled to the third edge of the first panel, the fourth panel being opposite and parallel to the third panel in the upright configuration. The fifth panel may be hingedly coupled to the fourth edge of the first panel, the fifth panel being opposite and parallel to the second panel in the upright configuration. The sixth panel may be hingedly coupled to the fifth panel, the sixth panel being opposite and parallel to the first panel in an upright closed configuration defining an enclosed space bounded by each of the first, the second, the third, the fourth, the fifth, and the sixth panels.

The reusable container may be included in a container monitoring system which may further include the radio receiver and the first computer. The first computer may be a smartphone. The smartphone may include a customer container monitoring application configured for providing instructions to the microcontroller device of the sensor and control assembly.

The reusable container may be configurable between upright and collapsible configurations. The reusable container may include a first panel, a second panel, a third panel, a fourth panel, a fifth panel and a sixth panel. The first panel may have a substantially rectangular shape defining first, second, third, and fourth edges. The second panel may be hingedly coupled to the first edge of the first panel. The third panel may be hingedly coupled to the second edge of the first panel, the third panel being perpendicular to the second panel in the upright configuration. The fourth panel may be hingedly coupled to the third edge of the first panel, the fourth panel being opposite and parallel to the third panel in the upright configuration. The fifth panel may be hingedly coupled to the fourth edge of the first panel, the fifth panel being opposite and parallel to the second panel in the upright configuration. The sixth panel may be hingedly coupled to the fifth panel, the sixth panel being opposite and parallel to the first panel in an upright closed configuration defining an enclosed space bounded by each of the first, the second, the third, the fourth, the fifth, and the sixth panels.

The reusable container may include a power source configured to electrically power the microcontroller device. The reusable container may include a sensor in electrical or optical communication with the microcontroller configured for transmitting sensor signals corresponding to sensor data to the microcontroller. The sensor data may correspond to operational or environmental information. The sensor data may be stored by the microcontroller. The microcontroller may be configured for transmitting controller sensor data corresponding to the sensor data to the local area network. The reusable container may include a display in electrical or optical communication with the microcontroller. The display may be configured for displaying display data corresponding to display signals received from the microcontroller. The display data may be based on the sensor data. The sensor may be selected from the group consisting of a thermometer, a humidity sensor, a contact switch, an accelerometer, a barometer, and a pressure transducer. The sensor may be a contact switch configured to detect a closed configuration of the container portion or an open configuration of the container portion, the detected closed or open configuration being the sensor data. The wireless communication device may be configured to wirelessly connect to the radio receiver upon the microcontroller device receiving the sensor data to identify the location of the container.

In certain alternative embodiments, a reusable container configurable between upright and collapsible configurations may include a first panel, a second panel, a third panel, a fourth panel, a fifth panel and a sixth panel. The first panel may have a substantially rectangular shape defining first, second, third, and fourth edge. The second panel may be hingedly coupled to the first edge of the first panel. The third panel may be hingedly coupled to the second edge of the first panel, the third panel being perpendicular to the second panel in upright configuration. The fourth panel may be hingedly coupled to the third edge of the first panel, the fourth panel being opposite and parallel to the third panel in the upright configuration. The fifth panel may be hingedly coupled to the fourth edge of the first panel, the fifth panel being opposite and parallel to the second panel in the upright configuration. The sixth panel may be hingedly coupled to the fifth panel, the sixth panel being opposite and parallel to the first panel in an upright closed configuration defining an enclosed space bounded by each of the first, the second, the third, the fourth, the fifth, and the sixth panels; and electronic componentry received inside the second panel.

The first panel may include a recess. The sixth panel may include a protrusion positioned such that the protrusion of the reusable container is configured to correspond and mate with the recess of an additional reusable container when in a stacked configuration with the reusable container. The second, third, fourth and fifth panels may be configured to fold approximately ninety degrees and thereby lie in a plane parallel to the first panel. The electronic componentry may include a microcontroller device and a sensor in electrical or optical communication with the microcontroller. The microcontroller device and sensor may be configured to be removed from the second panel, modified, and returned inside the second panel to change the functionality of the container. The microcontroller device may include a microcontroller and a wireless radio receiver in electrical communication with the microcontroller. The microcontroller may be configured to be programmed wirelessly from a wireless radio transmitter. The container may include a display in electrical or optical communication with the microcontroller. The display may be an electrophoretic display. The microcontroller may be configured to control a timing of detection of operational or environmental information associated with the container by the sensors.

A method of use of a reusable container may include receiving, via a microcontroller device of the reusable container, sensor signals provided by a sensor and corresponding to operational or environmental data identifying detection of a change in operational or environmental parameters associated with the reusable container; receiving, via a wireless radio of the microcontroller device, location signals corresponding to a location of a first external device of the reusable container upon receipt of the sensor signals; recording, on a memory storage device of or associated with a microcontroller of the microcontroller device, sensor data corresponding to the sensor signals and location data corresponding to the location signals; and transmitting the information from the Bluetooth wireless radio of the microcontroller to a Bluetooth receiver external to the reusable container.

The method of using a reusable container may include transporting the reusable container through the supply chain. The method may include displaying on a display of the reusable container information corresponding to either one or both of the sensor data and the location data. The method may include transmitting from the wireless radio of the microcontroller device recorded data signals corresponding to the sensor data. The method may include receiving the recorded data signals at the first external device or at a second external device. The method may include programming the microcontroller wirelessly via the wireless radio of the microcontroller device. The Bluetooth receiver may be configured to transmit the information to an inventory management system to provide system-wide supply chain visibility of the reusable container.

### BRIEF DESCRIPTION OF THE DRAWINGS

FIGS. 1A and 1B are top and bottom perspective views, respectively, of a reusable container in an upright closed configuration according to an embodiment of the disclosure.

FIG. 2 is a top perspective view of the reusable container of FIG. 1 in an upright open configuration.

FIGS. 3A-3C are perspective views of the reusable container of FIG. 1 in various stages of the reusable container transitioning between the upright configuration and a collapsed configuration.

FIGS. 4A and 4B are schematic cross-sectional views of the reusable container of FIG. 1 in an upright and a collapsed configuration, respectively.

FIG. 5 is a block diagram illustrating the relationships among electrical components of the reusable container of FIG. 1.

### DETAILED DESCRIPTION

As used herein, the terms “about,” “generally,” “approximately,” and “substantially” are intended to mean that slight deviations from absolute are included within the scope of the term so modified. However, unless otherwise indicated, the lack of any such terms should not be understood to mean than such slight deviations from absolute are not included within the scope of the term so modified. It should be understood that directional terms such as “upper,” “lower,” “side,” “front,” and “rear” may be used to refer to relative locations for ease of description, but these terms are not intended to limit the scope of the present disclosure.

A reusable container, as described herein, may include physical components and electrical components. It is contemplated that all or any combination of less than all of the components described below may be part of the reusable container. Thus, certain components may be omitted from the reusable container, depending on the functionality and cost-to-benefit ratio desired by or acceptable to an end user.

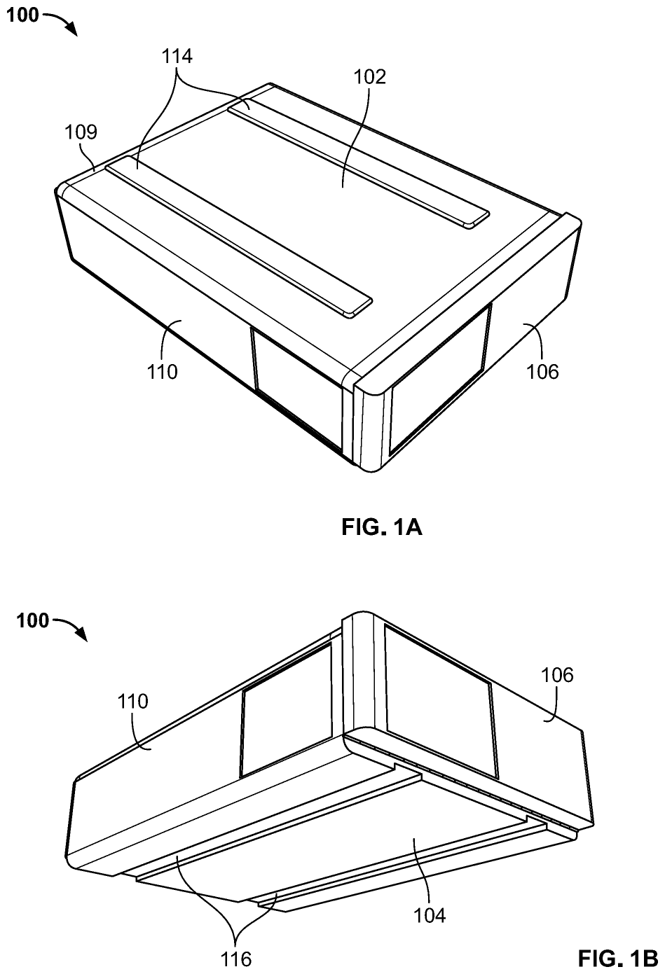

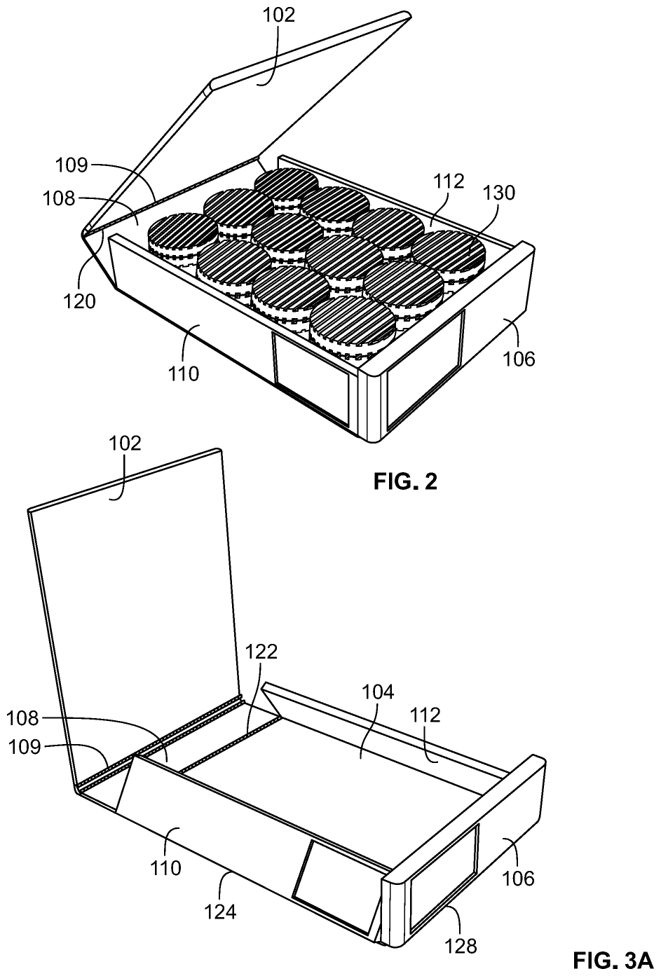

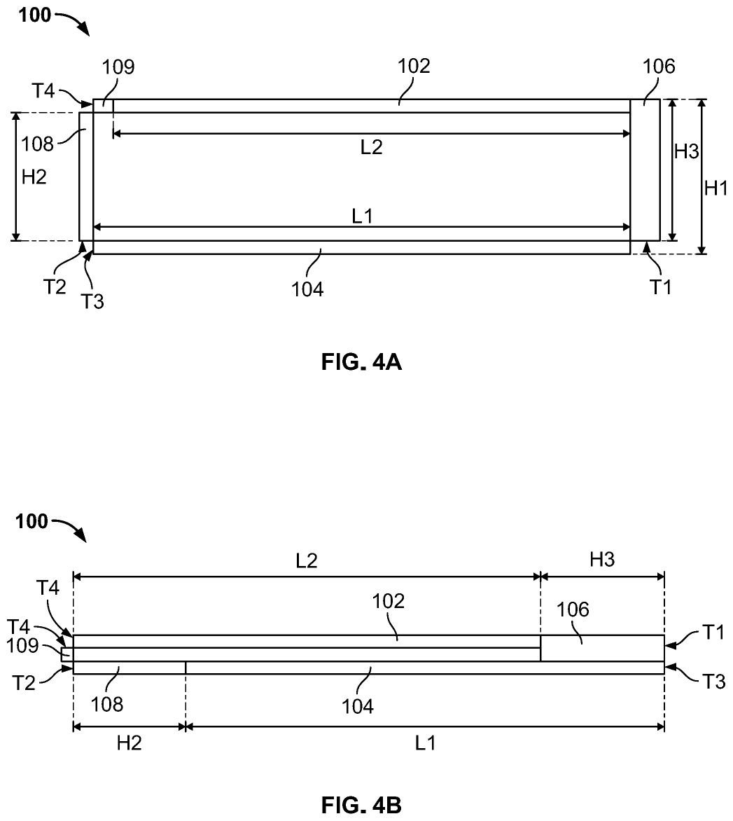

Referring now to FIGS. 1A and 1B, reusable container 100 is configurable into an upright closed configuration forming a box shape. Reusable container 100 includes an upper panel 102, a lower panel 104, a front panel 106, and a first side panel 110. Shown more clearly in FIG. 2, reusable container 100 also includes a second side panel 112 opposite first side panel 110 and a rear panel 108 opposite front panel 106. Reusable container 100 further includes a hinge 109 coupled to upper panel 102 and rear panel 108, which is shown and described below in more detail with reference to FIGS. 4A and 4B. In the upright closed configuration, the edges of each panel are generally adjacent an edge of an adjacent panel such that reusable container 100 forms a box defining an enclosed space inside the panels.

Referring again to FIG. 1A, upper panel 102 further includes protrusions 114. In the illustrated embodiment, protrusions 114 extend longitudinally along upper panel 102 in a direction parallel to side panels 110, 112. As shown in FIG. 1B, lower panel 104 includes recesses 116. In the illustrated embodiment, recesses 116 extend longitudinally along lower panel 104 parallel to side panels 110, 112 and are sized and shaped to receive the protrusions of the upper panel of a second reusable container. It is contemplated that containers may include any combination of at least one protrusion on a panel of a first container and at least one corresponding recess on a panel of a second container such that the protrusion is adapted to mate with the recess. The protrusion and recess may have any appropriate size, shape and location on their respective panels. It is contemplated that a protrusion may be included on the lower panel and a recess may be included on the upper panel. In some examples, a similar protrusion and recess combination may also be included on the front and rear panels or the first and second side panels. The mating of the protrusions of a first container with the recesses of a second reusable container facilitates ease and stability for stacking a plurality of containers.

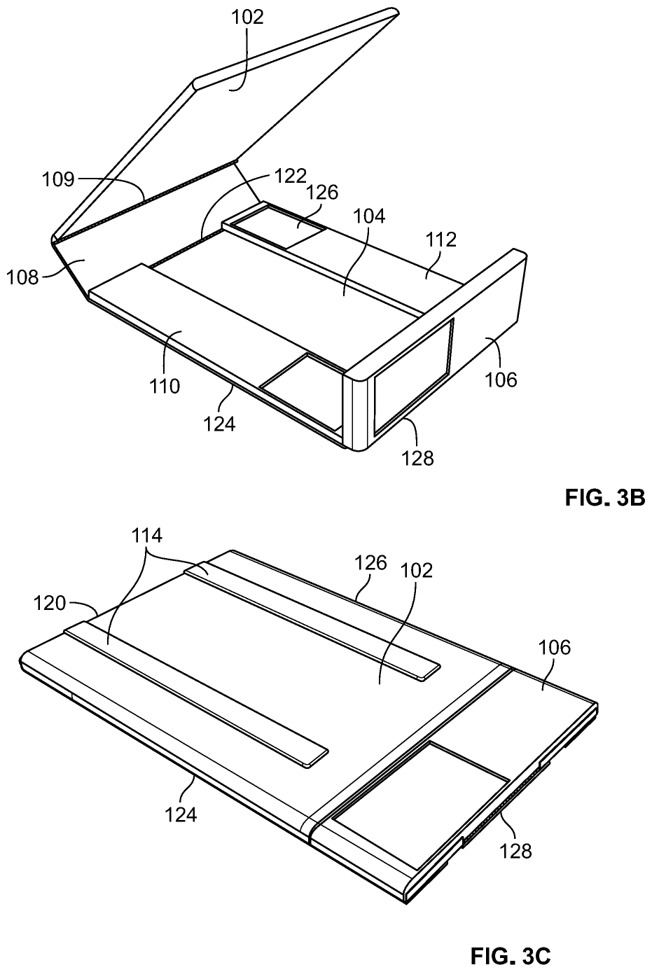

Referring again to FIG. 2, in the open configuration, lower panel 104, front panel 106, and side panels 110, 112 remain substantially in the same position and orientation as in the closed upright configuration. In the upright open configuration, upper panel 102 may fold open and separate from front panel 106 and side panels 110, 112. That is, upper panel 102 and hinge 109 may rotate with respect to rear upper edge 120 of rear panel 108. Further, rear panel 108 may rotate with respect to lower panel 104 at rear lower edge 122 (shown in FIGS. 3A-B) where rear panel 108 couples to lower panel 104. In the upright open configuration, reusable container 100 may define an enclosed space with the exception of upper panel 102. Alternatively, reusable container 100 may define an enclosed space with the exception of upper panel 102 and rear panel 108. In an alternate embodiment, the upper panel and rear panel of the container may rotate about a hinge defining an upper edge of the rear panel and a rear edge of the upper panel.

The reusable container may be constructed with any dimensions suitable for the goods contained therein. The weight and volume of the reusable container may be selected based on what is appropriate for safe and ergonomic handling in consideration of the goods contained therein. In the example shown in FIG. 2, reusable container 100 has a length measuring about 19.875 inches, a width measuring about 14.3125 inches, and a height measuring about 4.75 inches. Reusable container 100, in this example, is filled with fresh beef patties 130, each patty 130 having a net weight of approximately 1.6 ounces, arranged in layers of 12 patties in a 4×3 configuration stacked five layers high.

The reusable container may be constructed of materials that promote durability, shock-absorbing properties, insulating properties, and high strength-to-weight ratio. For example, the panels may be composed of expanded polypropylene (EPP) material with reinforcements at corners and high contact spots. Further, edges and corners and high-contact spots such as the protrusions and recesses may be reinforced or covered with more compressible materials, e.g., or with more rigid materials, e.g., a layer of polycarbonate and/or acrylonitrile butadiene styrene (ABS), relative to the rest of the panels. It is also contemplated that edges, corners and high-contact spots may consist completely of polycarbonate and/or ABS. The durability of the container may reduce physical damage to goods (including when stacked), and insulation may reduce damage to goods due to temperature and other environmental abuse.

Reusable container 100 may be configured to transition from an upright configuration to a collapsed configuration. The steps for such a transition of the illustrated embodiment are shown in FIGS. 3A-3C. In FIG. 3A, rear panel 108 is folded along rear lower edge 122 away from side panels 110, 112 such that rear panel 108 and lower panel 104 are substantially coplanar. Further, first side panel 110 may be folded inward toward the center of reusable container 100 along a first side lower edge 124 and second side panel 112 may be folded inward toward center of reusable container 100 along second side lower edge 126. First and second side panels 110, 112 may be folded such that they are adjacent to lower panel 104 and lie in a plane parallel to that of lower panel 104, as shown in FIG. 3B. Further, upper panel 102 may be folded at hinge 109 over folded side panels 110, 112, and front panel 106 may be folded along a front lower edge 128, such that both upper panel 102 and front panel 106 lay flat on top of folded side panels 110, 112 as shown in FIG. 3C, which illustrates the reusable container 100 in a collapsed configuration. The hinge and edges on which the panels fold allow for a transition between the upright configuration and the efficient collapsed configuration with ease and allows for stacking of reusable containers 100 in both the upright and collapsed configurations by mating grooves of a first container with recesses of a second container. It is also contemplated that a reusable container in an upright configuration may mate and stack effectively with a reusable container in a collapsed configuration. In further examples, the container may include front, rear, upper and side panels of varying sizes for alternative forms of collapsed configurations. For instance, the front, rear and upper panels may be sized such that front panel folds down and upper panel folds over rear panel and lies on top of it. Side panels may be sized such that one side panel may fold down and the opposing side panel may fold over the first side panel and lie on top of it.

FIGS. 4A-B illustrate how the dimensions of reusable container 100 change as container 100 transitions from an upright configuration (shown in FIG. 4A) to a collapsed configuration (shown in FIG. 4B). Lower panel 104 defines a length L1. The length L1 may also be the length of the interior of space of container 100. Upper panel 102 defines a length L2. The difference between length L1 and length L2 is the thickness of hinge 109. Container 100 defines a height H1. Rear panel 108 defines a height H2. Front panel 106 defines a height H3. Front panel 106 defines a thickness T1. Rear panel 108 defines a thickness T2. Lower panel 104 defines a thickness T3. Upper panel 102 and hinge 109 both define a thickness T4. In the illustrated embodiment, hinge 109 defines a square cross section, however other shaped cross-sections are contemplated, such as a rectangle. Height H1 is equal to the sum of height H3 and thickness T3, which is also equal to the sum of height H2 and thicknesses T3 and T4.

In some examples, length L1 measures about 18.375 inches, length L2 measures about 17.875 inches, height H1 measures about 4.75 inches, height H2 measures about 3.75 inches, height H3 measures about 4.25 inches, thickness T1 measures about 1 inch and thicknesses T2-4 measure about 0.5 inches. In the illustrated embodiment, the increased thickness of front panel 106 relative to the other panels allows for container 100 to form a flat surface in the collapsed configuration between upper panel 102 and front panel 106 when upper panel 102 and front panel 106 are folded over side panels 110, 112. Further, the increased thickness of front panel 106 may provide a housing for embedded or otherwise inserted electrical components and may provide improved support for a latching mechanism, both of which are described below. It is contemplated that the dimension and shape of container may be modified to meet optimal size and weight requirements suitable for the contents contained therein. In examples of the container having dimension varying from those described above, the total height of the container (i.e., height H1) may measure less than half of the total length (i.e., the sum of length L1, thickness T1 and thickness T2), thus allowing the capability of container to transition from an upright configuration to a collapsed configuration as described above.

The reusable container may be secured closed with spring-loaded latches. In some examples, the container may include two latches which may lock the container while in a resting position, and may be unlocked by simultaneously applying a force to each of the two latches in a direction away from each other (e.g., toward the outside of the container), to transition the latches into an unlocked condition and enable the upper panel to be opened.

The reusable container may include at least one of the electrical components further described below. As described above, certain components may be omitted from the reusable container depending on the functionality and cost-to-benefit ratio desired by the end user. The electrical components may be embedded or otherwise inserted in front panel 106 of container 100. Electrical components may be programmable wirelessly. In some examples, container 100 may be modular such that electrical components may be accessed physically to allow easy installation, modification and customization of electrical components in container 100. For example, any sensors further described below may be included or omitted based on a user's preferences.

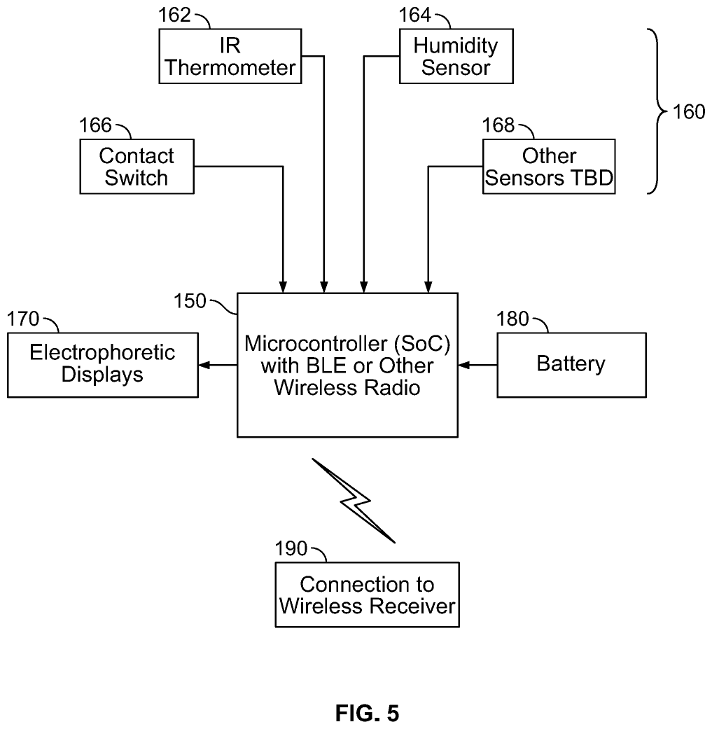

With reference to FIG. 5, in one example, reusable container 100 includes microcontroller 150 (which may also be referred to as system on a chip, or SoC), sensors 160, display 170, and battery (or power source) 180. Microcontroller device 150 may send and/or receive electrical or optical signals providing data corresponding to information or instructions to/from control sensors 160, display 170, and/or battery 180 as will be discussed below in greater detail. Microcontroller device 150 may include a wireless radio, flash memory, random-access memory (RAM), an embedded antenna, and/or interfaces to sensor inputs and display outputs. In some arrangements, microcontroller 150 may include one megabyte of flash memory. In some arrangements, microcontroller 150 may include 64K of RAM. The flash memory and RAM may support running firmware, which may be programmed to facilitate operations of the electrical components.

The firmware may be used to aid in the rotation of inventory of containers and products disposed inside of containers. In other words, information such as present time/date, time/date of production of goods, time/date of initial filling of container 100 may be programmed into the firmware such that the firmware may inform a user of production and filling dates, thereby assisting the user in determining an order in which a designated container among surrounding containers within a point-of-use (e.g., a restaurant storage area) should be used. Such information (e.g., date of production, date of filling, product code information, etc.) may be communicated to the container 100 via a wireless receiver 190 (e.g., Bluetooth receiver), as will be described below in greater detail. The firmware may also detect and alert a user of food that may have expired based on specified dates. Such a system may reduce waste due to improved inventory precision and planning, reduced improper inventory rotation, and reduced unexplained inventory losses. The firmware may be configured to facilitate user interaction with reusable container 100. The firmware may be customizable via custom programming to address the needs of a user. In still further examples, the firmware may be configured to record and communicate information, including information about a wireless receiver 190 adapted to connect to microcontroller device 150 via the wireless radio of the microcontroller device. It is contemplated that changes and updates to firmware may be enacted wirelessly when container 100 is in wireless contact with receiver 190, e.g., a Bluetooth receiver.

The sensor inputs 160 in reusable container 100 may include a thermometer 162, a humidity sensor 164, a contact switch 166, and any other suitable sensors 168 desired by a user and known to those skilled in the art. Sensors 160 are configured to be controlled by microcontroller device 150, which may act as a switch and activator in controlling the timing of the detection, e.g., sampling rate frequency, of operational, environmental, or other parameters associated with reusable container 100 by sensors 160. Thermometer 162 may sense and measure the temperature of an internal space of reusable container 100 when the container is in an upright configuration, e.g., a closed upright configuration. Thermometer 162 may also sense the temperature of any product contained within reusable container 100, such as beef patties 130 illustrated in FIG. 2. Thermometer 162 may measure temperature by any suitable means, such as an infrared thermometer, a mercury thermometer, a thermocouple, etc. Thermometer 162 may send the measured information to microcontroller device 150 for storage via a connection between the thermometer and the microcontroller device. In one example, a temperature threshold setting may be established on the firmware of microcontroller device 150, and any surpassing of that threshold as recorded by thermometer 162 may result in an output alerting the user of the temperature variation.

Similarly, humidity sensor 164 may sense humidity levels within the internal space of reusable container 100 when container 100 is in an upright configuration, e.g., a closed upright configuration. The humidity level detected by humidity sensor 164 may be relayed to microcontroller device 150 for storage via a connection between the humidity sensor and the microcontroller device.

Contact switch 166 may detect the open or closed orientation of reusable container 100. For example, when reusable container 100 is in a closed upright configuration and upper panel 102 contacts front panel 106 and/or side panels 110, 112, contact switch 166 may detect the configuration of the upper panel 102 and provide a first output to the microcontroller device indicating the closed configuration of reusable container 100. Alternatively, when reusable container 100 is in an open upright configuration and upper panel 102 does not contact front panel 106 and/or side panels 110, 112, contact switch 166 may detect the configuration of upper panel 102 and provide a second output to the microcontroller device indicating the open configuration of reusable container 100. Contact switch 166 may be coupled to microcontroller device 150 to send the output information to the microcontroller device for storage. In some examples, microcontroller device 150 may receive the information from contact switch 166 indicating that container 100 has transitioned from a closed configuration to an open configuration and search for and/or connect to the nearest receiver (e.g., Bluetooth receiver) to identify an approximate location in which container 100 has been opened. Some examples of other sensors 168 which may be included on reusable container 100 are a global positioning system (GPS) receiver, one or more accelerometers for shock or other vibratory indications, one or more barometers, one or more pressure transducers to detect weight, etc.

Display 170 may be one or more electrophoretic displays. Display 170 may be positioned on any panel of reusable container 100. Display 170 may serve a purpose similar to a label or printed content, and may further function as an informational panel. In addition to display 170, reusable container 100 may include additional signage, such as a brushed aluminum plaque or other durable signage, to communicate fixed-state item information that need not be changed dynamically. In some examples, a container may include between one and four electrophoretic displays 170 and between zero and four fixed signs. In some examples, electrophoretic display 170 may measure approximately three inches in a first direction (e.g., length) and five inches in a second direction (e.g., width). In some examples, electrophoretic display 170 or a fixed-state sign may be included on the front panel, but any location on the container is contemplated. Electrophoretic display 170 may require a higher cost than a fixed-state sign, and thus, a user may customize a reusable container 100 to include an appropriate number of each of electrophoretic displays 170 and fixed-state signage to optimize the cost and utility of container 100.

The information displayed by display 170 is configured to be modified by microcontroller device 150. In the example described above with reference to a temperature variation detected by the thermometer inside container 100, the user may be alerted via display 170, e.g., a message on the display reciting: “WARNING: Possible temperature abuse, do not use.” In other examples, display 170 may display information to the user to optimize the order and rotation in which the goods of multiple containers are used. For example, among a group of containers to be used in a first-in-first-out (FIFO) model, display 170 may inform or prompt the user of an order in which to use the goods container therein. That is, in a group of twelve containers, a message on display 170 may recite, e.g., “USE IN SEQUENCE: THIS IS #1 of 12.” It is contemplated that electrophoretic display 170 may operate similarly to a fixed image in that the display may not require power while displaying an image in a fixed state but may only require power, such as from a battery or an external power source including such a source known to those skilled in the art providing power wirelessly, to change the display.

In this regard, reusable container 100 may include battery 180 coupled to microcontroller device 150. Battery 180 may comprise at least one single use battery, such as a 1.5 volt alkaline AA battery or a button cell or coin-shaped battery. Alternatively, battery 180 may comprise a rechargeable battery such as a lithium-ion battery. Remaining battery life may be measured and recorded by microcontroller device 150 via a voltage signal inbound from battery 180. Remaining battery life may be determined by microcontroller device 150 based on a threshold battery life expectancy stored in the microcontroller device and displayed on display 170. In some examples, microcontroller device 150 may be configured to deliver a message or warning to a user when the battery level drops below a designated threshold to indicate that the container should be set aside for battery replacement. It is contemplated that reusable container 100 may include parallel cell configurations to extend battery life by decreasing the frequency in which a battery must be replaced.

The wireless radio included in microcontroller device 150 may be a Bluetooth® low energy (BLE) radio. A BLE wireless radio may be used to locate container 100, e.g., when used in conjunction with a local area network such as receiver 190 (e.g., a Bluetooth receiver) or a receiver in combination with a computer. A computer may be a personal computer, smartphone, data server, etc., and combinations and collections thereof. Receiver 190 may operate or be operated to identify a signal from the BLE wireless radio disposed on container 100. The location of receiver 190 may be used by microcontroller device 150 as an approximate location of container 100 or, as appropriate or desired, may be used by the microcontroller device to determine a location of the container by applying data associated with the location of the receiver to an algorithm stored in the microcontroller device. Further, data received and recorded by microcontroller device 150 may be transmitted via the wireless BLE connection to receiver 190. Receiver 190 may subsequently transmit said information to central servers via a connection to the Internet or other communication network. The central servers may feed data input to an inventory management system to provide system-wide supply chain visibility of the containers across the supply chain.

In some examples, information may be communicated wirelessly to the container via the receiver (e.g., Bluetooth receiver) in the production facility. A BLE wireless radio may be suitable in a foodservice environment where locating the reusable container within the supply chain may be achieved via Bluetooth receivers at various nodes, such as a point of shipping from a supplier/manufacturer, transportation carriers, distribution center docks (receiving and shipping), and restaurant inventory locations. The container may communicate with Bluetooth receivers at any or all these nodes and record its location (including other data from sensor inputs received by, and as appropriate, recorded by the microcontroller device) via methods such as dedicated Bluetooth receivers or custom applications on smartphones. The location information gathered when the container connects to a Bluetooth receiver serves to identify where the container is located in the supply chain and provide a key input used in the logic managed by the microcontroller to provide appropriate updates to the microcontroller and to provide appropriate information to the Bluetooth receivers the container may encounter on its journey in the supply chain.

In other examples, a GPS receiver may be included to track the location of container 100. In still further examples, the wireless radio may be Wi-Fi and the container may communicate with Wi-Fi receivers to pinpoint an approximate location of the container and transmit data. It should be understood that transmitting data via BLE may substantially reduce the cost of the container as well as the cost of use relative to other described methods. That is, a BLE wireless radio may cost less than GPS, Wi-Fi, or 5G, and the ubiquity of Bluetooth receivers already in place in a chain of supply may be utilized, thus eliminating the immense cost of installing and operating a GPS receiver or cellular radio in each individual unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A reusable container comprising:
a container portion; and
a microcontroller device including a microcontroller and a wireless communication device,
wherein the wireless communication device is configured for wireless communication with a local area network including at least a first radio receiver or the first radio receiver and a first computer, the local area network being external to the reusable container, to determine location data corresponding to a location of the container based on at least a location of the radio receiver or the first computer, and
wherein the microcontroller is configured to store the location data.

2. The reusable container of claim 1, wherein the wireless communication device is a Bluetooth® low energy wireless radio.

3. The reusable container of claim 2, wherein the radio receiver is part of a local area network including a first computer.

4. The reusable container of claim 1, wherein the microcontroller includes firmware programmed onto the microcontroller and configured to be updated wirelessly upon the microcontroller device receiving update signals corresponding to firmware update instructions from the local area network.

5. The reusable container of claim 4, wherein the firmware update instructions correspond to custom updates provided by an external user as desired by the user.

6. A container monitoring system, comprising:
the reusable container of claim 1;
the radio receiver; and
the first computer, the first computer being a smartphone.

7. The container monitoring system of claim 6, wherein the smartphone includes a customer container monitoring application configured for providing instructions to the microcontroller device of the sensor and control assembly.

8. The reusable container of claim 1 configurable between upright and collapsible configurations comprising:
a first panel having a substantially rectangular shape defining first, second, third, and fourth edges;
a second panel hingedly coupled to the first edge of the first panel;
a third panel hingedly coupled to the second edge of the first panel, the third panel being perpendicular to the second panel in the upright configuration;
a fourth panel hingedly coupled to the third edge of the first panel, the fourth panel being opposite and parallel to the third panel in the upright configuration;
a fifth panel hingedly coupled to the fourth edge of the first panel, the fifth panel being opposite and parallel to the second panel in the upright configuration;
a sixth panel hingedly coupled to the fifth panel, the sixth panel being opposite and parallel to the first panel in an upright closed configuration defining an enclosed space bounded by each of the first, the second, the third, the fourth, the fifth, and the sixth panels.

9. The reusable container of claim 1, further comprising a sensor in electrical or optical communication with the microcontroller and configured for transmitting sensor signals corresponding to sensor data to the microcontroller, the sensor data corresponding to operational or environmental information.

10. The reusable container of claim 9, wherein the sensor data is stored by the microcontroller and the microcontroller is configured for transmitting controller sensor data corresponding to the sensor data to the local area network.

11. The reusable container of claim 9, wherein the sensor is selected from the group consisting of a thermometer, a humidity sensor, a contact switch, an accelerometer, a barometer, and a pressure transducer.

12. The reusable container of claim 9, wherein the sensor is a contact switch configured to detect a closed configuration of the container portion or an open configuration of the container portion, the detected closed or open configuration being the sensor data.

13. The reusable container of claim 9, wherein the wireless communication device is configured to wirelessly connect to the radio receiver upon the microcontroller device receiving the sensor data to identify the location of the container.

14. A reusable container configurable between upright and collapsible configurations comprising:
a first panel having a substantially rectangular shape defining first, second, third, and fourth edges;
a second panel hingedly coupled to the first edge of the first panel;
a third panel hingedly coupled to the second edge of the first panel, the third panel being perpendicular to the second panel in upright configuration;
a fourth panel hingedly coupled to the third edge of the first panel, the fourth panel being opposite and parallel to the third panel in the upright configuration;
a fifth panel hingedly coupled to the fourth edge of the first panel, the fifth panel being opposite and parallel to the second panel in the upright configuration;
a sixth panel hingedly coupled to the fifth panel, the sixth panel being opposite and parallel to the first panel in an upright closed configuration defining an enclosed space bounded by each of the first, the second, the third, the fourth, the fifth, and the sixth panels; and electronic componentry received inside the second panel.

15. The reusable container of claim 14, wherein the first panel includes a recess and the sixth panel includes a protrusion positioned such that the protrusion of the reusable container is configured to correspond and mate with the recess of an additional reusable container when in a stacked configuration with the reusable container.

16. The reusable container of claim 14, wherein the second, third, fourth and fifth panels are configured to fold approximately ninety degrees and thereby lie in a plane parallel to the first panel.

17. The reusable container of claim 14, wherein the electronic componentry include a microcontroller device and a sensor in electrical or optical communication with the microcontroller.

18. The reusable container of claim 17, wherein the microcontroller device includes a microcontroller and a wireless radio receiver in electrical communication with the microcontroller, the microcontroller thereby being configured to be programmed wirelessly from a wireless radio transmitter.

19. The reusable container of claim 17, wherein the microcontroller is configured to control a timing of detection of operational or environmental information associated with the container by the sensors.

20. A method of use of a reusable container comprising:
receiving, via a microcontroller device of the reusable container, sensor signals provided by a sensor and corresponding to operational or environmental data identifying detection of a change in operational or environmental parameters associated with the reusable container;
receiving, via a wireless radio of the microcontroller device, location signals corresponding to a location of a first external device of the reusable container upon receipt of the sensor signals;
recording, on a memory storage device of or associated with a microcontroller of the microcontroller device, sensor data corresponding to the sensor signals and location data corresponding to the location signals; and
transmitting the information from the Bluetooth wireless radio of the microcontroller to a Bluetooth receiver external to the reusable container.
